(19) United States
(12) Patent Application Publication
(10) Pub. No.: US 2021/0259197 A1
(43) Pub. Date: Aug. 26, 2021

(54) Enclosed Litter Box Assembly

(71) Applicant: Gianna Hunt, Bethel Park, PA (US)

(72) Inventor: Gianna Hunt, Bethel Park, PA (US)

(21) Appl. No.: 16/801,759

(22) Filed: Feb. 26, 2020

(51) Int. Cl. A01K 1/01; A01K 1/00

(52) U.S. Cl. CPC A01K 1/0107; A01K 1/0047

(57) ABSTRACT

An enclosed litter box assembly for containing odors associated with feline defecation and urination includes a box for containing kitty litter to accommodate feline defecation and urination. The box has an entry way extending into the box. A ramp releasably engages the box to assist elderly or disabled felines to pass through the entry way. A tray is positionable within the box and the kitty litter positioned therein. A lid is positionable on the box for covering the box and the lid has a pair of vents each extending therethrough to pass air therethrough for venting the box. A pair of filters is each removably coupled to the lid to absorb odors associated with the feline defecation and urination.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to litter box devices and more particularly pertains to a new litter box device for feline defecation and urination.

### BRIEF SUMMARY OF THE INVENTION

An embodiment of the disclosure meets the needs presented above by generally comprising a box for containing kitty litter to accommodate feline defecation and urination. The box has an entry way extending into the box. A ramp releasably engages the box to assist elderly or disabled felines to pass through the entry way. A tray is positionable within the box and the kitty litter positioned therein. A lid is positionable on the box for covering the box and the lid has a pair of vents each extending therethrough to pass air therethrough for venting the box. A pair of filters is each removably coupled to the lid to absorb odors associated with the feline defecation and urination.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an enclosed litter box assembly according to an embodiment of the disclosure.

FIG. 2 is an exploded perspective view of an embodiment of the disclosure.

FIG. 3 is a right side view of an embodiment of the disclosure.

FIG. 4 is a front view of an embodiment of the disclosure.

FIG. 5 is a cross sectional view taken along line 5-5 of FIG. 1 of an embodiment of the disclosure.

### DETAILED DESCRIPTION OF THE INVENTION

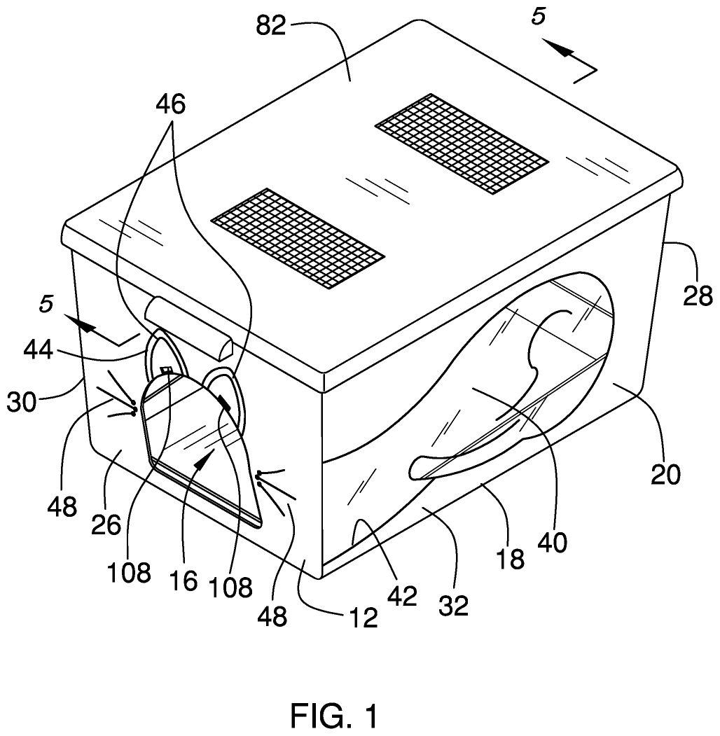

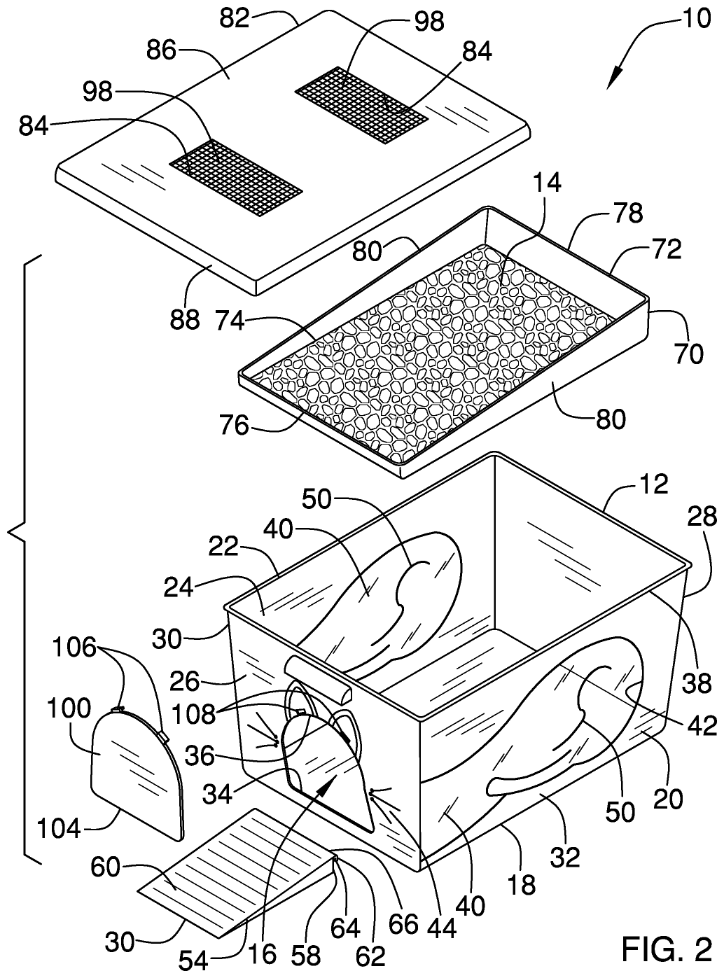

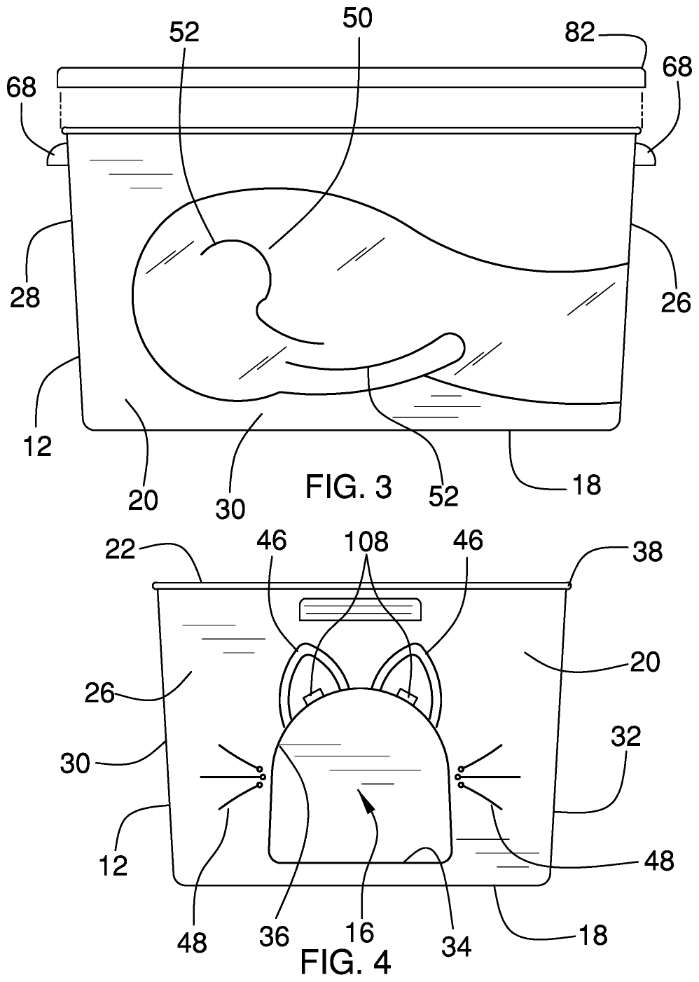

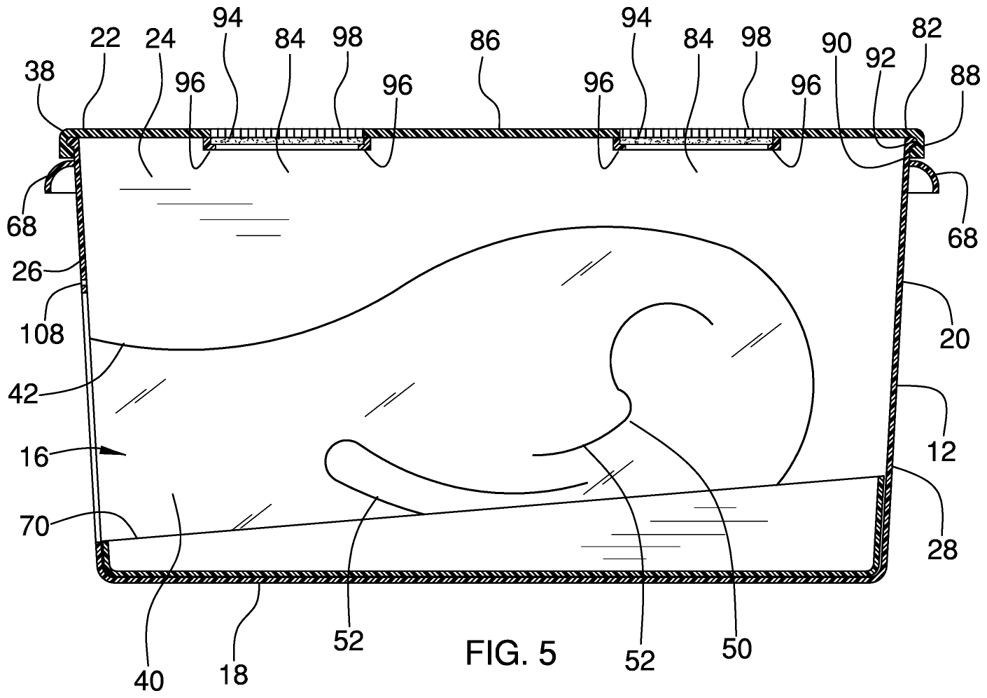

With reference now to the drawings, and in particular to FIGS. 1 through 5 thereof, a new litter box device embodying the principles and concepts of an embodiment of the disclosure and generally designated by the reference numeral 10 will be described.

As best illustrated in FIGS. 1 through 5, the enclosed litter box assembly 10 generally comprises a box 12 for containing kitty litter 14 to accommodate feline defecation and urination. The box 12 has an entry way 16 extending into the box 12 to facilitate a feline to enter the box 12. The box 12 has a bottom wall 18 and a perimeter wall 20 extending upwardly therefrom, and the perimeter wall 20 has a distal edge 22 with respect to the bottom wall 18 defining an opening 24 into the box 12. The perimeter wall 20 has a front side 26, a back side 28, a first lateral side 30 and a second lateral side 32, and the entry way 16 extends through the front side 26 of the perimeter wall 20.

The entry way 16 has a bottom bounding edge 34 and an upper bounding edge 36. The upper bounding edge 36 is convexly arcuate with the bottom bounding edge 34 such that the entry way 16 has a Quonset shape. The perimeter wall 20 of the box 12 has a prominence 38 extending outwardly therefrom. The prominence 38 is aligned with the distal edge 22 of the perimeter wall 20 and the prominence 38 is coextensive with the distal edge 22.

Each of the first 30 and second 32 lateral sides has a translucent portion 40 thereby facilitating an interior of the box 12 to be visible from outside of the box 12. The translucent portion 40 of each of the first 30 and second 32 lateral sides has a bounding edge 42. Moreover, the bounding edge 42 of the translucent portion 40 of each of the first 30 and second 32 lateral sides is curved to define the profile of a feline body. The translucent portion 40 of each of the first 30 and second 32 lateral sides extends from the front side 26 of the perimeter wall 20 toward the back side 28 of the perimeter wall 20.

The front side 26 of the perimeter wall 20 has indicia 44 printed thereon and the indicia 44 comprise a pair of feline ears 46 each extending upwardly from the upper bounding edge 36 of the entry way 16. The indicia 44 further comprise feline whiskers 48 each extending laterally away from opposite sides of the upper bounding edge 36 of the entry way 16. Each of the first 30 and second 32 lateral sides of the perimeter wall 20 of the box 12 has indicia 50 printed thereon. The indicia 50 on each of the first 30 and second 32 lateral sides is positioned on the translucent portion 40 of the first 30 and second 32 lateral sides. Moreover, the indicia 50 on each of the first 30 and second 32 lateral sides comprise a plurality of lines 52 that suggest haunches and a tail of a feline.

A ramp 54 is provided that releasably engages the box 12. The ramp 54 is aligned with the entry way 16 to assist elderly or disabled felines to pass through the entry way 16. The ramp 54 has a forward side 56, a rear side 58 and a top side 60 extending therebetween, and the top side 60 slopes upwardly between the forward 56 and rear 58 sides. The rear side 58 is positioned against the front side 26 of the perimeter wall 20 of the box 12. In this way the top side 60 slopes upwardly from a support surface to the bottom bounding edge 34 of the entry way 16.

A retainer 62 is coupled to the ramp 54 and the retainer 62 comprises a leg 64 and a foot 66. The leg 64 extends away from the rear side 58 of the ramp 54. Additionally, the foot 66 is spaced from and extends downwardly along the rear side 58 of the ramp 54. The bottom bounding edge 34 of the entry way 16 is positioned between the foot 66 and the rear side 58 of the ramp 54 for retaining the ramp 54 against the front side 26 of the box 12.

A pair of grips 68 is each of the grips 68 is coupled to the box 12 for gripping and subsequently carrying the box 12. Each of the grips 68 is positioned on a respective one of the front 26 and back 28 sides of the perimeter wall 20 of the box 12. Additionally, each of the grips 68 is aligned with the distal edge 22 of the perimeter wall 20 of the box 12. Each of the grips 68 may comprise a concavely arcuate handle or the like for accommodating fingers when the grips 68 are gripped.

A tray 70 is provided and the tray 70 is positionable within the box 12 and the kitty litter 14 is positioned in the tray 70. The tray 70 has a lip 72 extending upwardly therefrom to inhibit the kitty litter 14 from spilling outwardly from the box 12. The tray 70 has a basal wall 74 and the lip 72 extends upwardly from the basal wall 74. The lip 72 is coextensive with a perimeter of the basal wall 74. The lip 72 has a forward side 76, a rear side 78 and a pair of lateral sides 80. Each of the lateral sides 80 slopes upwardly between the forward side 76 and the rear side 78 of the lip 72 such that the rear side 78 of the lip 72 has a height that is greater than a height of the forward side 76 of the lip 72.

The forward side 56 is aligned with the bottom bounding edge 34 of the entry way 16 in the box 12 when the tray 70 is positioned in the box 12. In this way the forward side 56 will not inhibit the feline from entering the tray 70 when the feline passes through the entry way 16. The basal wall 74 rests on the bottom wall 18 of the box 12 when the tray 70 is positioned in the box 12. The tray 70 is comprised of a fluid impermeable material to inhibit unabsorbed feline urine from passing into the box 12.

A lid 82 is provided and the lid 82 is positionable on the box 12 for covering the box 12. The lid 82 has a pair of vents 84 each extending therethrough to pass air therethrough for venting the box 12. The lid 82 has a topmost wall 86 and a peripheral wall 88 extending downwardly from the topmost wall 86. Each of the vents 84 extends through the topmost wall 86 and the vents 84 are spaced apart from each other. The topmost wall 86 rests on the distal edge 22 of the perimeter wall 20 of the box 12 when the lid 82 is positioned on the box 12. The peripheral wall 88 extends downwardly along the perimeter wall 20 of the box 12 when the lid 82 is positioned on the box 12 for inhibiting the lid 82 from sliding off of the box 12.

The peripheral wall 88 has an inwardly facing surface 90 and the inwardly facing surface 90 has a groove 92 extending therein. The groove 92 is coextensive with the peripheral wall 88. Additionally, the groove 92 engages the prominence 38 on the perimeter wall 20 of the box 12 when the lid 82 is positioned on the box 12. In this way the lid 82 is releasably retained on the box 12.

A pair of filters 94 is provided and each of the filters 94 is removably coupled to the lid 82. Each of the filters 94 is aligned with a respective one of the vents 84. Additionally, each of the filters 94 is comprised of an air permeable material to pass air therethrough. Moreover, each of the filters 94 is comprised of an odor absorbing media, such as charcoal or the like. In this way each of the filters 94 absorbs odors associated with the feline defecation and urination. The lid 82 may include a plurality of rails 96 that each extends downwardly from the topmost wall 86 of the lid 82. Each of the rails 96 may be aligned with respective ones of the vents 84 and each of the rails 96 may support a respective one of the filters 94. A pair of screens 98 may each being coupled to the lid 82 and be positioned in a respective one of the vents 84. Each of the screens 98 may be comprised of a mesh material or other air permeable material.

A door 100 is provided and the door 100 is removably attached to the box and having the door 100 being aligned with the entry way 16. The door 100 has an outer edge 104 and the outer edge 104 has a profile that is coextensive with the bottom bounding edge 34 and upper bounding edge 36 of the entry way 16. A pair of first engagements 106 is each coupled to the door 10 and each of the first engagements 106 is aligned with the outer edge 104. A pair of second engagements 108 is each coupled to the front side of the perimeter wall of the box. Each of the second engagements 108 is positioned above the entry way 16. Each of the first engagements 106 releasably engages a respective one of the second engagements 108 such that the door 100 is hingedly coupled to the box 12. In this way the door 100 can swing inwardly and outwardly to facilitate the feline to pass through the door 100. Additionally, the door 100 may be comprised of a translucent material.

In use, kitty litter 14 is poured into the tray 70 and the tray 70 is positioned in the box 12 and the lid 82 is positioned on the box 12. Thus, a feline can enter through the entry way 16 to defecate or urinate in the kitty litter 14. The lid 82 and each of the filters 94 inhibit odors in the box 12 from passing outwardly through the box 12 thereby enhancing the odor of the surrounding environment. The ramp 54 can be positioned against the box 12 and be aligned with the entry way 16 for assisting elderly or disabled felines to enter the box 12. The lid 82 removed from the box 12 and the tray 70 is removed from the box 12 for emptying and subsequently replacing the kitty litter 14 in the tray 70.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An enclosed litter box assembly being configured to contain kitty litter for accommodating feline defecation and urination, said assembly comprising:
a box for containing kitty litter wherein said box is configured to accommodate feline defecation and urination, said box having an entry way extending into said box wherein said entry way is configure to have a feline enter therethrough;
a ramp releasably engaging said box, said ramp being aligned with said entry way wherein said ramp is configured to assist elderly or disabled felines to pass through said entry way;
a pair of grips, each of said grips being coupled to said box for gripping and subsequently carrying said box;
a tray being positionable within said box wherein said tray is configured to have the kitty litter positioned therein, said tray having a lip extending upwardly therefrom wherein said lip is configured to inhibit the kitty litter from spilling outwardly from said box;
a lid being positionable on said box for covering said box, said lid having a pair of vents each extending therethrough wherein each of said vents is configured to pass air therethrough for venting said box;
a pair of filters, each of said filters being removably coupled to said lid, each of said filters being aligned with a respective one of said vents, each of said filters being comprising of an air permeable material wherein each of said filters is configured to pass air therethrough, each of said filters being comprised of an odor absorbing media wherein each of said filters is configured to absorb odors associated with the feline defecation and urination.

2. The assembly according to claim 1, wherein:
said box has a bottom wall and a perimeter wall extending upwardly therefrom, said perimeter wall having a distal edge with respect to said bottom wall defining an opening into said box, said perimeter wall having a front side, a back side, a first lateral side and a second lateral side, said entry way extending through said front side of said perimeter wall; and
each of said first and second lateral sides having a translucent portion thereby facilitating an interior of said box to be visible from outside of said box, said translucent portion of each of said first and second lateral sides having a bounding edge, said bounding edge of said translucent portion of each of said first and second lateral sides being curved to define the profile of a feline body, said translucent portion of each of said first and second lateral sides extending from said front side of said perimeter wall toward said back side of said perimeter wall, said entry way having a bottom bounding edge and an upper bounding edge, said upper bounding edge being convexly arcuate with said bottom bounding edge such that said entry way has a Quonset shape.

3. The assembly according to claim 2, wherein:
said front side of said perimeter wall has indicia being printed thereon, said indicia comprising a pair of feline ears each extending upwardly from said upper bounding edge of said entry way, said indicia comprising feline whiskers each extending laterally away from opposite sides of said upper bounding edge of said entry way; and
each of said first and second lateral sides of said perimeter wall of said box has indicia being printed thereon, said indicia on each of said first and second lateral sides being positioned on said translucent portion of said first and second lateral sides, said indicia on each of said first and second lateral sides comprising a plurality of lines that suggest haunches and a tail of a feline.

4. The assembly according to claim 3, wherein said perimeter wall of said box has a prominence extending outwardly therefrom, said prominence being aligned with said distal edge of said perimeter wall, said prominence being coextensive with said distal edge.

5. The assembly according to claim 2, wherein said ramp has a forward side, a rear side and a top side extending therebetween, said top side sloping upwardly between said forward and rear sides, said rear side being positioned against said front side of said perimeter wall of said box wherein said top side is configured to slope upwardly from a support surface to a lower bounding edge of said entry way.

6. The assembly according to claim 5, further comprising a retainer being coupled to said ramp, said retainer comprising a leg and a foot, said leg extending away from said rear side of said ramp having said foot being spaced from and extending downwardly along said rear side of said ramp, said lower bounding edge of said entry way being positioned between said foot and said rear side of said ramp for retaining said ramp against said front side of said box.

7. The assembly according to claim 2, wherein said tray has a basal wall, said lip extending upwardly from said basal wall, said lip being coextensive with a perimeter of said basal wall, said lip having a forward side, a rear side and a pair of lateral sides, each of said lateral sides sloping upwardly between said forward side and said rear side of said lip such that said rear side of said lip has a height being greater than a height of said forward side of said lip, said forward side of said lip being aligned with said bottom bounding edge of said entry way in said box when said tray is positioned in said box wherein said forward side of said lip is configured to not inhibit the feline from entering said tray when the feline passes through said entry way, said basal wall resting on said bottom wall of said box when said tray is positioned in said box.

8. The assembly according to claim 4, wherein said lid has a topmost wall and a peripheral wall extending downwardly from said topmost wall, each of said vents extending through said topmost wall, said vents being spaced apart from each other, said topmost wall resting on said distal edge of said perimeter wall of said box when said lid is positioned on said box, said peripheral wall extending downwardly along said perimeter wall of said box when said lid is positioned on said box for inhibiting said lid from sliding off of said box.

9. The assembly according to claim 8, wherein said peripheral wall has an inwardly facing surface, said inwardly facing surface having a groove extending therein, said groove being coextensive with said peripheral wall, said groove engaging said prominence on said perimeter wall of said box when said lid is positioned on said box for releasably retaining said lid on said box.

10. The assembly according to claim 2, further comprising a door being positionable in said entry way for closing said entry way, said door having an outer edge, said outer edge having a profile being coextensive with said bottom bounding edge and said upper bounding edge of said entry way.

11. An enclosed litter box assembly being configured to contain kitty litter for accommodating feline defecation and urination, said assembly comprising:
a box for containing kitty litter wherein said box is configured to accommodate feline defecation and urination, said box having an entry way extending into said box wherein said entry way is configure to have a feline enter therethrough, said box having a bottom wall and a perimeter wall extending upwardly therefrom, said perimeter wall having a distal edge with respect to said bottom wall defining an opening into said box, said perimeter wall having a front side, a back side, a first lateral side and a second lateral side, said entry way extending through said front side of said perimeter wall, each of said first and second lateral sides having a translucent portion thereby facilitating an interior of said box to be visible from outside of said box, said translucent portion of each of said first and second lateral sides having a bounding edge, said bounding edge of said translucent portion of each of said first and second lateral sides being curved to define the profile of a feline body, said translucent portion of each of said first and second lateral sides extending from said front side of said perimeter wall toward said back side of said perimeter wall, said entry way having a bottom bounding edge and an upper bounding edge, said upper bounding edge being convexly arcuate with said bottom bounding edge such that said entry way has a Quonset shape, said front side of said perimeter wall having indicia being printed thereon, said indicia comprising a pair of feline ears each extending upwardly from said upper bounding edge of said entry way, said indicia comprising feline whiskers each extending laterally away from opposite sides of said upper bounding edge of said entry way, each of said first and second lateral sides of said perimeter wall of said box having indicia being printed thereon, said indicia on each of said first and second lateral sides being positioned on said translucent portion of said first and second lateral sides, said indicia on each of said first and second lateral sides comprising a plurality of lines that suggest haunches and a tail of a feline, said perimeter wall of said box having a prominence extending outwardly therefrom, said prominence being aligned with said distal edge of said perimeter wall, said prominence being coextensive with said distal edge;
a ramp releasably engaging said box, said ramp being aligned with said entry way wherein said ramp is configured to assist elderly or disabled felines to pass through said entry way, said ramp having a forward side, a rear side and a top side extending therebetween, said top side sloping upwardly between said forward and rear sides, said rear side being positioned against said front side of said perimeter wall of said box wherein said top side is configured to slope upwardly from a support surface to said bottom bounding edge of said entry way;
a retainer being coupled to said ramp, said retainer comprising a leg and a foot, said leg extending away from said rear side of said ramp having said foot being spaced from and extending downwardly along said rear side of said ramp, said bottom bounding edge of said entry way being positioned between said foot and said rear side of said ramp for retaining said ramp against said front side of said box;
a pair of grips, each of said grips being coupled to said box for gripping and subsequently carrying said box, each of said grips being positioned on a respective one of said front and back sides of said perimeter wall of said box, each of said grips being aligned with said distal edge of said perimeter wall of said box;
a tray being positionable within said box wherein said tray is configured to have the kitty litter positioned therein, said tray having a lip extending upwardly therefrom wherein said lip is configured to inhibit the kitty litter from spilling outwardly from said box, said tray having a basal wall, said lip extending upwardly from said basal wall, said lip being coextensive with a perimeter of said basal wall, said lip having a forward side, a rear side and a pair of lateral sides, each of said lateral sides sloping upwardly between said forward side of said lip and said rear side of said lip such that said rear side of said lip has a height being greater than a height of said forward side of said lip, said forward side of said lip being aligned with said bottom bounding edge of said entry way in said box when said tray is positioned in said box wherein said forward side of said lip is configured to not inhibit the feline from entering said tray when the feline passes through said entry way, said basal wall resting on said bottom wall of said box when said tray is positioned in said box;
a lid being positionable on said box for covering said box, said lid having a pair of vents each extending therethrough wherein each of said vents is configured to pass air therethrough for venting said box, said lid having a topmost wall and a peripheral wall extending downwardly from said topmost wall, each of said vents extending through said topmost wall, said vents being spaced apart from each other, said topmost wall resting on said distal edge of said perimeter wall of said box when said lid is positioned on said box, said peripheral wall extending downwardly along said perimeter wall of said box when said lid is positioned on said box for inhibiting said lid from sliding off of said box, said peripheral wall having an inwardly facing surface, said inwardly facing surface having a groove extending therein, said groove being coextensive with said peripheral wall, said groove engaging said prominence on said perimeter wall of said box when said lid is positioned on said box for releasably retaining said lid on said box;
a pair of filters, each of said filters being removably coupled to said lid, each of said filters being aligned with a respective one of said vents, each of said filters being comprising of an air permeable material wherein each of said filters is configured to pass air therethrough, each of said filters being comprised of an odor absorbing media wherein each of said filters is configured to absorb odors associated with the feline defecation and urination; and
a door being positionable in said entry way for closing said entry way, said door having an outer edge, said outer edge having a profile being coextensive with said bottom bounding edge and said upper bounding edge of said entry way.
